(19) United States
(12) Patent Application Publication
(10) Pub. No.: US 2018/0367829 A1
(43) Pub. Date: Dec. 20, 2018

(54) METHOD FOR IMPLEMENTING DIGITAL RIGHTS MANAGEMENT (DRM)-ENABLED MEDIA GATEWAY/TERMINAL AND DEVICE THEREOF

(71) Applicants: Academy of Broadcasting Science, State Administration of Press, Publication, Radio, Film, Beijing (CN); Unitend Technologies Inc., Beijing (CN)

(72) Inventors: Zhifan SHENG, Beijing (CN); Xingjun WANG, Beijing (CN); Lei WANG, Beijing (CN); Zhijian LIANG, Beijing (CN); Peiyu GUO, Beijing (CN); Xiaoxia GUO, Beijing (CN)

(21) Appl. No.: 15/781,141

(22) PCT Filed: Dec. 1, 2016
(86) PCT No.: PCT/CN2016/108206

§ 371 Date: Jun. 3, 2018

(30) Foreign Application Priority Data
Dec. 3, 2015 (CN) 201510884723.7

(51) Int. Cl. H04N 21/254; H04N 21/266

(52) U.S. Cl. CPC H04N 21/2541; H04N 21/26613; H04N 21/26606

(57) ABSTRACT

Disclosed is a method for implementing a digital rights management-enabled media gateway. The media gateway comprises a trusted execution environment and a trusted application configured therein. The method comprises: acquiring a videoPid, an audioPid, a casId, an ecmPid, and an emmPid of a program; parsing the ecmPid and the emmPid using a parsing mechanism that matches the casId, obtaining encryption level keys EK1 and EK2 and an encryption control word ECW; descrambling the scrambled program data stream using the EK1, EK2, ECW, videoPid and audioPid of the program; generating a content encryption key CEK by the trusted application, encrypting the descrambled program data using the CEK and transmitting the same to the terminal; acquiring a public key from the terminal, encrypting the CEK with the public key by the trusted application to obtain an encrypted content encryption key ECEK and transmitting the ECEK to the terminal.

### FIELD OF THE INVENTION

The present invention relates to the field of digital copyright management technologies, and more particularly, to a method for implementing a digital rights management-enabled media gateway, a method for implementing a terminal of a media gateway, and a device thereof.

### BACKGROUND OF THE INVENTION

With the development of media convergence, especially the promulgation of the H265/HEVC (High Efficiency Video Coding) video coding standard, mainstream mobile phones/PADs and set-top box chips have begun to support the operation of H265/HEVC and UHD (Ultra High Definition)/4K content. It becomes possible that more and more operators will regard UHD/4K services as the next business growth point. Moreover, content providers, especially major movie companies, have put forward more stringent copyright protection requirements for high-definition, UHD (Ultra High Definition)/4K and other high-quality content. At the the same time, the market formulated requirements for high-quality content protection for DRM systems and DRM terminals in response to the demand for content protection of large-scale film companies, in order to cope with more stringent copyright protection requirements.

On the other hand, with the rapid development and continuous popularization of home networks, the demand for sharing and managing digital copyrights of media content in home networks has been continuously increased. Especially for scrambled digital televisions, existing technical solutions are usually local area networks. The multiple terminals in the network need to have their own descrambling capability. That is, multiple set-top boxes and smart cards are purchased to descramble the scrambled digital television programs. It is impossible to share the media content of different terminals within the home network and impossible to realize digital rights management of shared media content in an LAN.

The “GY/T 277-2014 Internet Television Digital Rights Management Technical Specification” (hereinafter referred to as the China DRM standard) issued by the State Administration of Press, Publication, Radio, Film and Television of China defines the content package formats, rights description and authorization, rights acquisition protocols, and trust and security systems, which provides a new standard for the implementation of the DRM system. The China DRM standard has been widely used in Internet TV, IPTV and other fields.

Therefore, there is a need to propose a method for sharing digital television programs within a local area network while ensuring the security and copyright management of the shared copyrighted contents.

### SUMMARY OF THE INVENTION

It is an object of the present invention to provide a new technical solution for digital rights management (DRM)-enabled media gateways.

According to a first aspect of the present invention, there is provided a method for implementing a digital rights management (DRM)-enabled media gateway, the media gateway comprising a trusted execution environment (TEE) and a trusted application configured therein, and the method comprising the following steps: acquiring a list of all channel programs and transmitting the same to a terminal; receiving a channel program identifier transmitted from the terminal indicating a user's channel change instruction or program playing instruction to acquire a corresponding program data stream; if the corresponding program is a scrambled program, acquiring program parameters, the program parameters comprising a video stream identifier videoPid, an audio stream identifier audioPid, a conditional access application identifier casId, an entitlement control message identifier ecmPid, and an entitlement management message identifier emmPid of the channel program; parsing the entitlement control message identifier ecmPid and the entitlement management message identifier emmPid using a parsing mechanism that matches the conditional access application identifier casId, thereby obtaining encryption level keys EK1 and EK2 and an encryption control word ECW; descrambling the scrambled program data stream using the encryption level keys EK1 and EK2, the encryption control word ECW, the video stream identifier videoPid, and the audio stream identifier audioPid of the channel program; generating a content encryption key CEK by the trusted application in the trusted execution environment, and encrypting the descrambled program data using the content encryption key CEK and transmitting the same to the terminal; and acquiring a public key used to encrypt the content encryption key CEK from the terminal, encrypting the content encryption key CEK with the public key by the trusted application in the trusted execution environment to obtain an encrypted content encryption key ECEK, and transmitting the ECEK to the terminal.

Preferably, the trusted execution environment (TEE) comprises a hardware resource, an internel API, and a secure operating system that are isolated from an operating system of the media gateway.

Preferably, the media gateway further comprises a DRM digital certificate, and the method further comprises: transmitting the DRM digital certificate to the terminal for the terminal to perform certificate verification and validity authentication; and receive a DRM digital certificate transmitted by the terminal, and perform certificate verification and validity authentication on the DRM digital certificate transmitted by the terminal through the trusted application in the trusted execution environment, the DRM digital certificate transmitted by the terminal comprising the public key used to encrypt the content encryption key CEK.

Preferably, the method further comprises: if the corresponding program is a non-scrambled program, providing the acquired program data stream to the terminal.

Preferably, the program parameters also comprise a frequency locking parameter of the program, and the method further comprises: configuring the acquired frequency locking parameter of the program in a tuner of the media gateway, and configuring the video stream identifier videoPid and the audio stream identifier audioPid of the channel program in demultiplexer hardware to filter the program data stream.

Preferably, the method further comprises: before all steps, configuring an operation mode as a media gateway mode.

Preferably, the channel program identifier comprises an original network identifier onid, a transport stream identifier tsid, and a service identifier sid of the channel.

According to a second aspect of the present invention, there is provided a method for implementing a terminal of a digital rights management (DRM)-enabled media gateway, the terminal comprising a trusted execution environment (TEE) and a trusted application configured therein, the method comprising the following steps: requesting a list of all media channels from the media gateway; in response to a user's channel change instruction or program playing instruction, transmitting a switched channel program identifier to the media gateway; if the corresponding program is a scrambled program, acquiring a program data stream encrypted using a content encryption key CEK from the media gateway; transmitting a public key used to encrypt the content encryption key CEK to the media gateway; receiving an encrypted content encryption key ECEK encrypted with the public key transmitted by the media gateway, and configuring the same into the trusted application in the trusted execution environment; acquiring, by the trusted application in the trusted execution environment, a private key paired with the public key according to a preset mechanism, and decrypting the encrypted content encryption key ECEK by using the private key to obtain the content encryption key CEK; and decrypting the acquired encrypted program data stream using the content encryption key CEK for playing.

Preferably, the trusted execution environment (TEE) comprises a hardware resource, an internel API, and a secure operating system that are isolated from an operating system of the media gateway.

Preferably, the terminal further comprises a DRM digital certificate, and the method further comprises: transmitting the DRM digital certificate to the media gateway for the media gateway to perform certificate verification and validity authentication, the DRM digital certificate comprising the public key used to encrypt the content encryption key CEK; and receiving a DRM digital certificate transmitted by the media gateway, and performing certificate verification and validity authentication on the DRM digital certificate transmitted by the media gateway through the trusted application in the trusted execution environment.

Preferably, the method further comprises: if the corresponding program is a non-scrambled program, acquiring the program data stream from the media gateway.

Preferably, the method further comprises: before all steps, configuring an operation mode as a terminal mode.

Preferably, the channel program identifier comprises an original network identifier onid, a transport stream identifier tsid, and a service identifier sid of the channel.

According to a third aspect of the present invention, there is provided a digital rights management (DRM)-enabled media gateway device, the device comprising: a trusted execution environment (TEE) and a trusted application configured therein, a digital television gateway service module, a media processing module, a digital television module, a conditional access module and a DRM management service module, wherein the digital television module is configured to obtain a list of all channel programs and store the same; the digital television gateway service module is configured to acquire the list of all channel programs through the digital television module, transmit the same to the terminal, receive a channel program identifier transmitted from the terminal indicating a user's channel change instruction or program playing instruction, and provide the same to the media processing module; the digital television module is further configured to obtain the channel program identifier from the media processing module, determine whether the corresponding program is a scrambled program, and acquire program parameters if the corresponding program is a scrambled program, the program parameters comprising a video stream identifier videoPid, an audio stream identifier audioPid, a conditional access application identifier casId, an entitlement control message identifier ecmPid, an entitlement management message identifier emmPid of the channel program; the media processing module is configured to acquire, from the digital television module, the video stream identifier videoPid, the audio stream identifier audioPid, the conditional access application identifier casId, the entitlement control message identifier ecmPid, and the entitlement management message identifier emmPid of the channel program and transmit the same to the conditional access module; the conditional access module is configured to parse the entitlement control message identifier ecmPid and the entitlement management message identifier emmPid according to a parsing mechanism that matches the received conditional access application identifier casId, so as to obtain encryption level keys EK1 and EK2 and an encryption control word ECW; the media processing module is further configured to acquire the encryption level keys EK1 and EK2 and the encryption control word ECW from the conditional access module, and control descrambler hardware to descramble program data using the encryption level keys EK1 and EK2 and the encryption control word ECW; the DRM management service module is configured to control the trusted application in the trusted execution environment to generate a content encryption key CEK, control the trusted application to encrypt the descrambled program data using the content encryption key CEK and transmit the same to the terminal through the digital television gateway service module; and the trusted application in the trusted execution environment is configured to generate the content encryption key CEK and encrypt the descrambled program data using the content encryption key CEK, obtain from the terminal through the digital television gateway service module a public key used to encrypt the content encryption key CEK, encrypt the content encryption key CEK using the public key to obtain an encrypted content encryption key ECEK, and transmit the ECEK to the terminal.

Preferably, the trusted execution environment (TEE) comprises a hardware resource, an internel API, and a secure operating system that are isolated from an operating system of the media gateway.

Preferably, a DRM digital certificate is stored in the DRM management service module, and the digital television gateway service module is further configured to: acquire the DRM digital certificate through the DRM management service module and transmit the same to the terminal for the terminal to perform certificate verification and validity authentication; and receive a DRM digital certificate transmitted by the terminal, and perform certificate verification and validity authentication on the DRM digital certificate transmitted by the terminal through the trusted application in the trusted execution environment, the DRM digital certificate transmitted by the terminal comprising the public key used to encrypt the content encryption key CEK.

Preferably, the media processing module is further configured to: when the digital television module determines that the corresponding program is a non-scrambled program, provide the acquired program data stream to the terminal.

Preferably, the program parameters further comprise a frequency locking parameter of the program; and the media processing module is further configured to configure the acquired frequency locking parameter of the program into a tuner of the media gateway, and configure the video stream identifier videoPid and the audio stream identifier audioPid of the channel program to demultiplexer hardware to filter the program data stream.

Preferably, the digital television gateway service module is further configured to configure an operation mode as a media gateway mode.

Preferably, the channel program identifier comprises an original network identifier onid, a transport stream identifier tsid, and a service identifier sid of the channel.

According to a fourth aspect of the present invention, there is provided a terminal device of a digital rights management (DRM)-enabled media gateway, the device comprising a gateway application module, a trusted execution environment (TEE) and a trusted application configured therein, a digital television gateway service module, a media processing module, and a DRM management service module; wherein the gateway application module is configured to request a list of all channel programs from the media gateway and display the same through the digital television gateway service module, and transmit a switched channel program identifier to the media gateway in response to a user's channel change instruction or program playing instruction; the media processing module is configured to acquire a program data stream encrypted using a content encryption key CEK from the media gateway when the corresponding program is a scrambled program; the DRM management service module is configured to transmit a public key used to encrypt the content encryption key CEK to the media gateway through the digital television gateway service module, receive an encrypted content encryption key ECEK encrypted with the public key transmitted by the media gateway through the digital television gateway service module and configure the same into the trusted application in the trusted execution environment; the trusted application in the trusted execution environment is configured to acquire a private key paired with the public key according to a preset mechanism, and decrypt the encrypted content encryption key ECEK using the private key to obtain the content encryption key CEK; and the media processing module is further configured to control, by the DRM management service module, the trusted application in the trusted execution environment to decrypt the acquired encrypted program data stream using the content encryption key CEK for playing.

Preferably, the trusted execution environment (TEE) comprises a hardware resource, an internel API, and a secure operating system that are isolated from an operating system of the media gateway.

Preferably, the DRM management service module stores a DRM digital certificate, and the digital television gateway service module is further configured to: transmit the DRM digital certificate to the media gateway for the media gateway to perform certificate verification and validity authentication, the DRM digital certificate comprising the public key used to encrypt the content encryption key CEK; and receive a DRM digital certificate transmitted by the media gateway, and perform certificate verification and validity authentication on the DRM digital certificate transmitted by the media gateway through the trusted application in the trusted execution environment.

Preferably, the media processing module is further configured to obtain the program data stream from the media gateway when the corresponding program is a non-scrambled program.

Preferably, the digital television gateway service module is further configured to configure an operation mode to a terminal mode.

Preferably, the channel program identifier comprises an original network identifier onid, a transport stream identifier tsid, and a service identifier sid of the channel.

According to a fifth aspect of the present invention, there is provided a dual-function device of a digital rights management (DRM)-enabled media gateway, comprising a digital television gateway service module configured to configure an operation mode of the device as a media gateway mode or a terminal mode, wherein when the operation mode is configured as the media gateway mode, the device is configured to perform the method of the media gateway, and when the operating mode is configured as the terminal mode, the device is configured to perform the method of the terminal.

The inventors of the present invention have found that in the prior art, there has not been proposed a sharing solution for digital television that meets copyright management requirements in a local area network. Therefore, the technical task to be solved by the present invention or the technical problem to be solved is never expected or anticipated by a person skilled in the art, so the present invention is a new technical solution.

Other features and advantages of the present invention will become apparent from the following detailed description of exemplary embodiments of the present invention with reference to the accompanying drawings.

### BRIEF DESCRIPTION OF THE DRAWINGS

The accompanying drawings, which are incorporated in and constitute a part of the description, illustrate embodiments of the present invention and, together with the description thereof, serve to explain the principles of the present invention.

FIG. 1 shows a block diagram of a hardware configuration of a media gateway device/terminal device 1000 that can implement an embodiment of the present invention.

FIG. 2 shows a flowchart of a digital television digital rights management method for a media gateway according to a first embodiment of the present invention;

FIG. 3 shows a block diagram of a system according to second, third and fourth embodiments of the present invention; and

FIG. 4 shows a flowchart of a digital television digital rights management method for a terminal device according to a third embodiment of the present invention.

### DETAILED DESCRIPTION OF THE EMBODIMENTS

Various exemplary embodiments of the present invention will now be described in detail with reference to the accompanying drawings. It should be noted that the relative arrangement, numerical expressions and numerical values of the components and steps set forth in these examples do not limit the scope of the invention unless otherwise specified.

The following description of at least one exemplary embodiment is in fact merely illustrative and is in no way intended as a limitation to the present invention and its application or use.

Techniques, methods, and apparatus known to those of ordinary skill in the relevant art may not be discussed in detail but where appropriate, the techniques, methods, and apparatus should be considered as part of the description.

Among all the examples shown and discussed herein, any specific value should be construed as merely illustrative and not as a limitation. Thus, other examples of exemplary embodiments may have different values.

It should be noted that similar reference numerals and letters denote similar items in the accompanying drawings, and therefore, once an item is defined in a drawing, and there is no need for further discussion in the subsequent accompanying drawings.

<Hardware Configuration>

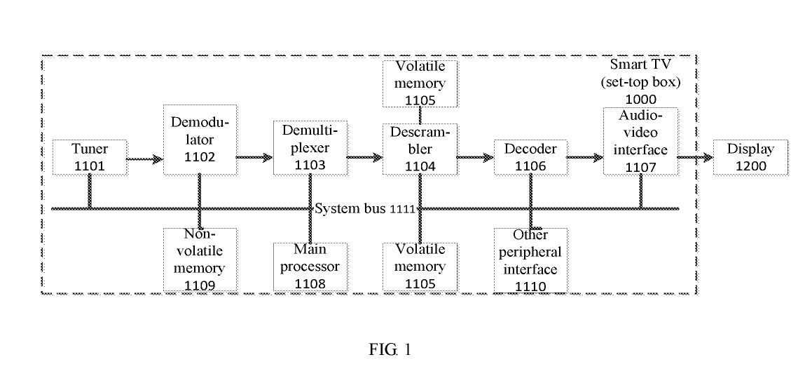

FIG. 1 is a block diagram illustrating a hardware configuration of a media gateway device 1000 that may implement an embodiment of the present invention. In one embodiment, the media gateway 1000 may be a set-top box or a television integrated with a set-top box.

As shown in FIG. 1, the media gateway 1000 typically comprises a main processor 1108, a tuner 1101 for receiving television signals, a demodulator 1102, a non-volatile memory 1109, a demultiplexer 1103, a descrambler 1104, a volatile memory 1105, a decoder 1106, an audio and video interface 1107, and other peripheral interfaces 1110, and also a display 1200 in case of a smart TV integrated with the TV and the set-top box connected via a system bus 1111.

The non-volatile memory 1109 hosts smart operating systems, applications, other program modules, and certain program data.

Likewise, a terminal device that can implement digital television digital rights management (DRM) can also have the same configuration.

The smart television shown in FIG. 1 is merely illustrative and is in no way meant to limit the present invention, its application or use.

### First Embodiment

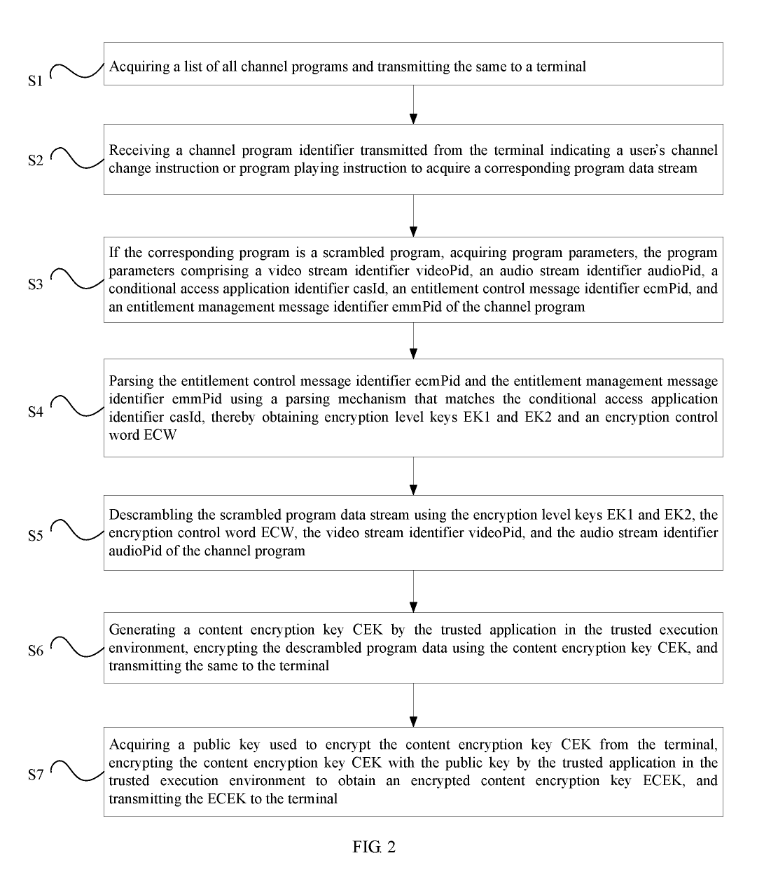

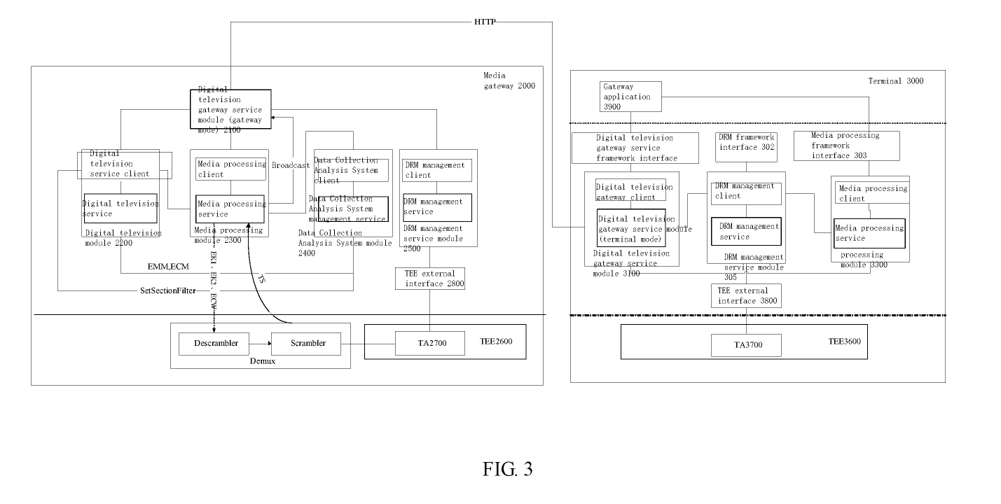

According to a first embodiment of the present invention, as shown in FIGS. 2 and 3, a method for implementing a digital video rights management (DRM)-enabled media gateway according to the present embodiment is implemented in a smart TV 2000 as a media gateway. In one embodiment, the smart TV 2000 may be a set-top box or an integrated set-top box. The media gateway 2000 comprises a trusted execution environment (TEE) 2600 that comprises a hardware resource, an internel API, and a secure operating system that are isolated from the smart operating system. The method comprises the following steps.

In step S1, a list of all channel programs is acquired and transmitted to a terminal 3000.

In step S2, a channel program identifier transmitted from the terminal 3000 indicating a user's channel change instruction or program playing instruction is received to acquire a corresponding program data stream, the channel program identifier comprising an original network identifier onid, a transport stream identifier tsid, and a service identifier sid of the channel.

In step S3, if the corresponding program is a scrambled program, program parameters are acquired, the program parameters comprising a video stream identifier videoPid, an audio stream identifier audioPid, a conditional access application identifier casId, an entitlement control message identifier ecmPid, and an entitlement management message identifier emmPid of the channel program. In particular, the parameters also include a frequency locking parameter of the program.

If the corresponding program is a non-scrambled program, the acquired program data stream is directly provided to the terminal.

In step S4, the entitlement control message identifier ecmPid and the entitlement management message identifier emmPid are parsed by using a parsing mechanism that matches the conditional access application identifier casId, so as to obtain encryption level keys EK1 and EK2 and an encryption control word ECW.

The process of parsing and obtaining the encryption level keys EK1 and EK2 and the encryption control word ECW further comprises obtaining entitlement control message data ecm Data and entitlement management message data emm Data by using the entitlement control message identifier ecmPid and the entitlement management message identifier emmPid and performing parsing to obtain the encryption level keys EK1 and EK2 and the encryption control word ECW according to the entitlement control message data ecm Data and the entitlement management message data emm Data.

The parsing mechanism that matches the conditional access application identifier casId may be configured in a conditional access application module (not shown). The conditional access application module may be a piece of software, a program, or a plug-in, may be downloaded, registered and loaded in an operating system of the media gateway, and parsed by the parsing mechanism in the conditional access application module to obtain the encryption level keys EK1 and EK2 and the encryption control word ECW. The parsing mechanism may also be preset in the trusted application 2700 of the trusted execution environment 2600, and the encryption level keys EK1 and EK2 and the encryption control word ECW are acquired by the parsing mechanism in the trusted application 2700. The conditional access application module or the trusted application may be provided by different conditional access manufacturers, thereby being adapted to the parsing mechanisms from different conditional access manufacturers.

In step S5, the encryption level keys EK1 and EK2, the encryption control word ECW, the video stream identifier videoPid, and the audio stream identifier audioPid of the channel program are used to descramble the scrambled program data stream.

In this step, preferably, the acquired frequency locking parameter of the program can be configured in the tuner of the media gateway 2000, and the video stream identifier videoPid and the audio stream identifier audioPid of the channel program can be configured in demultiplexer hardware to filter the program data stream and then descramble the program data stream.

In step S6, a content encryption key CEK is generated by the trusted application 2700 in the trusted execution environment 2600, and the descrambled program data is encrypted by using the content encryption key CEK and transmitted to the terminal 3000.

In step S7, a public key used to encrypt the content encryption key CEK is acquired from the terminal 3000, and the trusted application 2700 in the trusted execution environment 2600 encrypts the content encryption key CEK using the public key, thereby obtaining an encrypted content encryption key ECEK and transmitting the same to the terminal 3000.

In particular, the media gateway 2000 further comprises a DRM digital certificate, and the method further comprises a step of the media gateway 2000 and the terminal 3000 verifying each other's digital certificate.

That is, the media gateway 2000 transmits the DRM digital certificate to the terminal 3000 for the terminal 3000 to perform certificate verification and validity authentication; and a DRM digital certificate transmitted by the terminal 3000 is received, certificate verification and validity authentication are performed on the DRM digital certificate transmitted by the terminal through the trusted application 2700 in the trusted execution environment 2600. In particular, the DRM digital certificate transmitted by the terminal 3000 comprises the public key used to encrypt the content encryption key CEK, so that the public key required in step S7 is transmitted to the terminal 3000 in the certificate verification step.

In particular, the method also comprises a step of determining an operation mode as a media gateway mode before all the steps.

The above has been described according to the first embodiment of the present invention. The media gateway 2000 may be a TV set-top box or a smart TV integrated with a set-top box. In a local area network, digital television program data, particularly scrambled digital television program data may use the trusted execution environment TEE to implement the DRM function, thereby providing a sharing scheme for digital television programs in a local area network and a secure sharing scheme that meets the needs of digital rights management. In turn, it can support the free switching and adaptation of a plurality of conditional access manufacturers, and at the same time, it can also support a plurality of DRM manufacturers and freely switch among a plurality of DRM manufacturers; and it has the advantages of high security, scalability, and the like.

The TEE comprises hardware resources, Secure OS, TEE Internal API, trusted application modules and intelligent operating systems isolated from an operating system of the media gateway. The isolated hardware resources include CPUs, memories, and Secure Storages.

Secure Clocks, Encryption and Decryption Algorithms (Crypto APIs), Descramble Interfaces, etc. The interaction between the operating system and the trusted execution environment using the external interface of the trusted execution environment provides a trusted execution environment for the implementation of the DRM function and ensures the security of the DRM function.

### Second Embodiment

The first embodiment of the present invention has been described above with reference to the accompanying drawings. The second embodiment according to the present invention is described below. Parts not described are the the same as those of the first embodiment, and therefore will not be described repeatedly. According to the present embodiment, there is provided a digital television digital rights management (DRM)-enabled media gateway device 2000, referring to the left part of FIG. 3. The device 3000 comprises: a trusted execution environment (TEE) 2600 and a trusted application 2700 configured therein, a digital television gateway service module 2100, a media processing module 2300, a digital television module 2200, a conditional access (DCAS) module 2400, and a DRM management service module 2500. The trusted execution environment (TEE) comprises a hardware resource, an internel API, and a secure operating system that are isolated from an operating system of the media gateway.

The digital television module 2200 is configured to obtain a list of all channel programs and store the same.

The digital television gateway service module 2100 is configured to acquire the list of all channel programs and transmit the same to the terminal 3000 through the digital television module 2200, and receive a channel program identifier transmitted from the terminal 3000 indicating a user's channel change instruction or program playing instruction and provide the same to the media processing module 2300, the channel program identifier comprising the channel's original network identifier onid, transport stream identifier tsid, and service identifier sid.

The digital television module 2200 is further configured to obtain the channel program identifier from the media processing module 2300, determine whether the corresponding program is a scrambled program, and acquire program parameters if the corresponding program is a scrambled program. The program parameters include a video stream identifier videoPid, an audio stream identifier audioPid, a conditional access application identifier casId, an entitlement control message identifier ecmPid, and an entitlement management message identifier emmPid of the channel program. In particular, the parameters also include a frequency locking parameter of the program.

The media processing module 2300 is configured to acquire the video stream identifier videoPid, the audio stream identifier audioPid, the conditional access application identifier casId, the entitlement control message identifier ecmPid, and the entitlement management message identifier emmPid of the channel program from the digital television module 2200 and transmit the same to the conditional access module 2400.

The media processing module 2300 is further configured to directly provide the acquired program data stream to the terminal 3000 when the digital television module 2200 determines that the corresponding program is a non-scrambled program.

The conditional access module 2400 is configured to parse the entitlement control message identifier ecmPid and the entitlement management message identifier emmPid according to a parsing mechanism that matches the received conditional access application identifier casId, so as to obtain encryption level keys EK1 and EK2 and an encryption control word ECW.

The process of parsing and obtaining the encryption level keys EK1 and EK2 and the encryption control word ECW further comprises obtaining entitlement control message data ecm Data and entitlement management message data emm Data by using the entitlement control message identifier ecmPid and the entitlement management message identifier emmPid and perform parsing to obtain the encryption level keys EK1 and EK2 and the encryption control word ECW according to the entitlement control message data ecm Data and the entitlement management message data emm Data.

The parsing mechanism that matches the conditional access application identifier casId may be configured in a conditional access application module (not shown). The conditional access application module may be a piece of software, a program, or a plug-in, and may be downloaded, registered, and loaded in the operating system of the media gateway. The parsing mechanism in the conditional access application module performs parsing to obtain the encryption level keys EK1 and EK2 and the encryption control word ECW. The parsing mechanism may also be preset in the trusted application 2700 of the trusted execution environment 2600, and the encryption level keys EK1 and EK2 and the encryption control word ECW are acquired by the parsing mechanism in the trusted application 2700. The conditional access application module or the trusted application 2700 may be provided by different conditional access manufacturers, thereby being adapted to the parsing mechanisms of different conditional access manufacturers.

The media processing module 2300 is further configured to acquire the encryption level keys EK1 and EK2 and the encryption control word ECW from the conditional access module 2400, and control descrambler hardware to descramble the program data using the encryption level keys EK1 and EK2 and the encryption control word ECW.

The DRM management service module 2500 is configured to control the trusted application 2700 in the trusted execution environment 2600 to generate a content encryption key CEK and encrypt the descrambled program data by using the content encryption key CEK and transmit the same to the terminal 3000 through the digital television gateway service module 2100.

The trusted application 2700 in the trusted execution environment 2600 is configured to obtain the public key used to encrypt the content encryption key CEK from the terminal 3000 through the digital television gateway service module 2100, encrypt the content encryption key CEK using the public key to obtain an encrypted content encryption key ECEK, and transmit the ECEK to the terminal 3000.

In particular, a DRM digital certificate is stored in the DRM management service module 2500.

The digital television gateway service module 2100 is further configured to: acquire the DRM digital certificate through the DRM management service module 2500 and transmit the same to the terminal 3000 for the terminal 3000 to perform certificate verification and validity authentication; and receive a DRM digital certificate transmitted by the terminal 3000, and perform certificate verification and validity authentication on the DRM digital certificate transmitted by the terminal 3000 through the trusted application 2700 in the trusted execution environment 2600. The DRM digital certificate transmitted by the terminal 3000 comprises the public key used to encrypt the content encryption key CEK.

The media processing module 2300 is further configured to configure the acquired frequency locking parameter of the program into the tuner of the media gateway, and configure the video stream identifier videoPid and the audio stream identifier audioPid of the channel program to demultiplexer hardware to filter the program data stream.

In particular, the digital television gateway service module 2100 is further configured to determine that an operation mode is a media gateway mode.

Preferably, a TEE external interface 2800 is provided between the DRM management service module 2500 and the trusted execution environment 2600 for the DRM management service module to call a corresponding function of the TEE 2600. More preferably, the media processing module 2300, the digital television module 2200, the conditional access module 2400 and the DRM management service module 2500 are all component layer components of the operating system. The media processing module 2300 is implemented as a client-server structure comprising a media processing server as a server and a media processing client as a client. The client implements the transmitting and receiving of media processing requests, and the server processes and schedules the requests of the client and returns the processing result. Similarly, the digital television module 2200, the conditional access module 2400, and the DRM management service module 2500 are also implemented as a client-server architecture to support more complex task response and scheduling.

### Third Embodiment

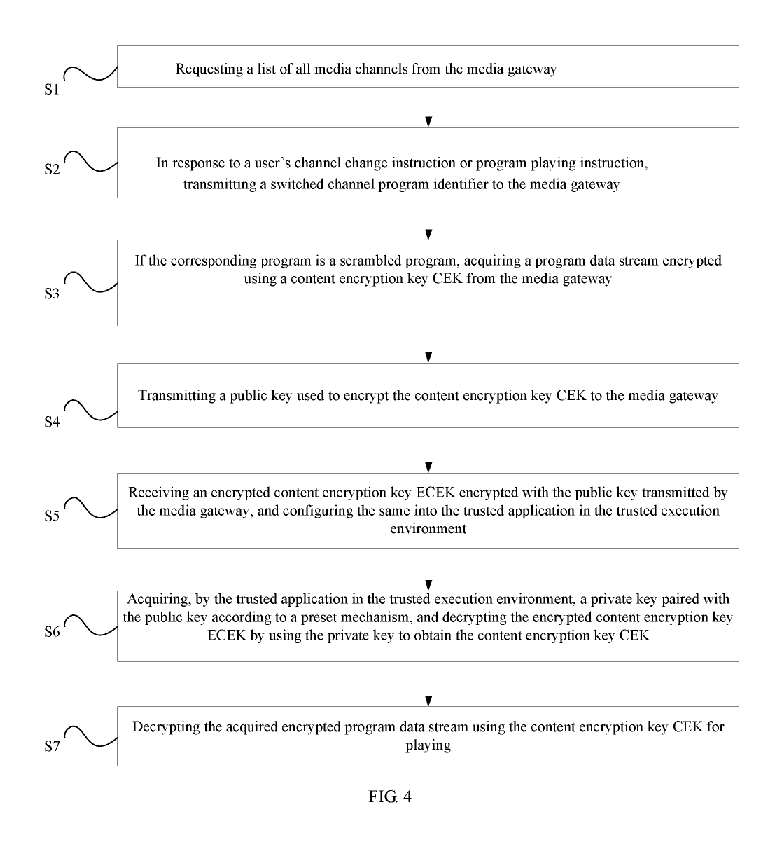

According to a third embodiment of the present invention, as shown in FIGS. 3 and 4, a method for implementing a terminal of a digital media management (DRM)-enabled media gateway according to the present embodiment is implemented in a smart television 3000 as a terminal. In one embodiment, the smart television 3000 may be a set-top box or an integrated set-top box. The terminal 3000 comprises a trusted execution environment (TEE) 3600 and a trusted application 3700 configured therein. The trusted execution environment (TEE) 3600 comprises a hardware resource, an internel API, and a secure operating system isolated from an operating system of the media gateway. The method comprises the following steps.

In step S1, a list of all channel programs is requested from the media gateway 2000.

In step S2, a switched channel program identifier is transmitted to the media gateway in response to a user's channel change instruction or program playing instruction, the channel program identifier comprising the channel's original network identifier onid, transport stream identifier tsid, and service identifier sid.

In step S3, if the corresponding program is a scrambled program, a program data stream encrypted using the content encryption key CEK is acquired from the media gateway 2000; and if the corresponding program is a non-scrambled program, the program data stream is acquired from the media gateway 2000.

In step S4, a public key used to encrypt the content encryption key CEK is transmitted to the media gateway 2000.

In step S5, the encrypted content encryption key ECEK encrypted with the public key transmitted by the media gateway is received and configured in the trusted application 3700 in the trusted execution environment 3600.

In step S6, a private key paired with the public key is acquired according to a preset mechanism by the trusted application 3700 in the trusted execution environment 3600, and the encrypted content encryption key ECEK is decrypted using the private key to obtain the content encryption key CEK.

In step S7, the acquired encrypted program data stream is decrypted using the content encryption key CEK for playing.

Specifically, the terminal 3000 further comprises a DRM digital certificate, and the method further comprises: transmitting the DRM digital certificate to the media gateway 2000 for the media gateway 2000 to perform certificate verification and validity authentication, the DRM digital certificate comprising the public key used to encrypt the content encryption key CEK; and receiving a DRM digital certificate transmitted by the media gateway 2000, and performing certificate verification and validity authentication on the DRM digital certificate transmitted by the media gateway through the trusted application 3700 in the trusted execution environment 3600.

Preferably, the method further comprises a step of determining that an operation mode is a terminal mode before all the steps.

The above has been described according to the third embodiment of the present invention. The terminal 3000 may be a TV set-top box or a smart TV integrated with a set-top box.

The digital TV program data, especially the scrambled digital TV program data, in a local area network uses the trusted execution environment TEE to achieve DRM functionality, thus providing a digital TV program sharing scheme within the LAN and a secure sharing scheme that meets the needs of digital rights management. In turn, it can support the free switching and adaptation of a plurality of conditional access manufacturers, and at the same time, it can also support a plurality of.

DRM manufacturers and freely switch among a plurality of DRM manufacturers; and it has the advantages of high security, scalability, and the like.

The TEE comprises hardware resources, Secure OS, TEE Internal API, trusted application modules, and intelligent operating systems isolated from an operating system of the media gateway. The isolated hardware resources include CPUs, memories, Secure Storages, Secure Clocks, Encryption and Decryption Algorithms (Crypto APIs), Descramble Interfaces, etc. The interaction between the operating system and the trusted execution environment using the external interface of the trusted execution environment provides a trusted execution environment for the implementation of the DRM function and ensures the security of the DRM function.

### Fourth Embodiment

The third embodiment of the present invention has been described above with reference to the accompanying drawings. The fourth embodiment according to the present invention is described below. Parts not described are the same as those of the third embodiment, and thus will not be described repeatedly. According to the present embodiment, there is provided a terminal device 3000 supporting a digital television digital rights management (DRM)-enabled media gateway, referring to the right part of FIG. 3. The device 3000 comprises a gateway application module 3900, a trusted execution environment (TEE) 3600 and a trusted application 3700 configured therein, a digital television gateway service module 3100, a media processing module 3300, and a DRM management service module 3500. The trusted execution environment (TEE) comprises a hardware resource, an internel API, and a secure operating system that are isolated from an operating system of the media gateway.

The gateway application module 3900 is configured to request the media gateway 2000 for a list of all the channel programs and display the same through the digital television gateway service module 3100, and to transmit a switched channel program identifier in response to a user's channel change instruction or program playing instruction to the media gateway 2000. Preferably, the channel program identifier comprises the channel's original network identifier onid, transport stream identifier tsid, and service identifier sid.

The media processing module 3300 is configured to acquire a program data stream encrypted using a content encryption key CEK from the media gateway 2000 when the corresponding program is a scrambled program.

The DRM management service module 3500 is configured to transmit a public key used to encrypt the content encryption key CEK to the media gateway 200 through the digital television gateway service module 3100, and receive an encrypted content encryption key ECEK encrypted with the public key transmitted by the media gateway 200 through the digital television gateway service module 3100 and configure the same in the trusted application 3700 in the 3600 trusted execution environment.

The trusted application 3700 in the trusted execution environment 3600 is configured to acquire a private key paired with the public key according to a preset mechanism, and decrypt the encrypted content encryption key ECEK using the private key to obtain the content encryption key CEK.

The media processing module 3300 is further configured to decrypt the acquired encrypted program data stream using the content encryption key CEK for playing.

In particular, a DRM digital certificate is stored in the DRM management service module 3500, and the digital television gateway service module 3100 is further configured to: transmit the DRM digital certificate to the media gateway 2000 for the media gateway 2000 to perform certificate verification and validity authentication, the DRM digital certificate comprising the public key used to encrypt the content encryption key CEK; and receive a DRM digital certificate transmitted by the media gateway 2000, and perform certificate verification and validity authentication on the DRM digital certificate transmitted by the media gateway through the trusted application 3700 in the trusted execution environment 3600.

In particular, the media processing module 3300 is further configured to obtain the program data stream from the media gateway 2000 when the corresponding program is a non-scrambled program.

In particular, the digital television gateway service module 3100 is further configured to determine that an operation mode is a terminal mode.

More preferably, between the gateway application 3900 and the digital television gateway service module 3100, a standardized digital television gateway service framework interface 301 is provided for the gateway application 3900 to call a corresponding function of the digital television gateway service module 3100. Between the gateway application 3900 and the media processing module 3300, a standardized media processing framework interface 303 is provided for the gateway application 3900 to call a corresponding function of the media processing module 3300. And between the DRM application module (not shown) and DRM management service module 3500, a standardized DRM framework interface 302 is provided for the DRM application module to invoke a corresponding function of the DRM management service module 3500. A TEE external interface 3800 is provided between the DRM management service module 3500 and the trusted execution environment 3600 for the DRM management service module to invoke a corresponding function of the TEE 3600.

### Fifth Embodiment

The first to fourth embodiments have been described above with reference to the drawings, and the following will describe the fifth embodiment of the present invention. According to the fifth embodiment of the present invention, with continued reference to FIG. 3, there is provided a dual-function device for implementing digital television digital rights management (DRM) which can be used both as a media gateway and as a terminal device, and comprises all elements and modules of the media gateway 2000 and the terminal device 3000, and the duplicated elements or modules can be shared. The dual-function device can switch between a media gateway mode and a terminal mode according to a mode selection function provided in the digital television gateway service module. In the media gateway mode, it follows the operation mode of the media gateway 2000 and operates in the manners shown in the first embodiment and the second embodiment. In the terminal mode, it follows the operation mode of the terminal device 3000 and operates in the manners shown in the third embodiment and the fourth embodiment. The dual-function device is preferably implemented as a smart television or set-top box.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. The scope of the present invention is defined by the attached claims.

1-13. (canceled)

14. A digital rights management (DRM)-enabled media gateway device, the device comprising: a trusted execution environment (TEE) and a trusted application configured therein, a digital television gateway service module, a media processing module, a digital television module, a conditional access module and a DRM management service module, wherein
the digital television module is configured to obtain a list of all channel programs and store the same;
the digital television gateway service module is configured to acquire the list of all channel programs through the digital television module, transmit the same to the terminal, receive a channel program identifier transmitted from the terminal indicating a user's channel change instruction or program playing instruction, and provide the same to the media processing module;
the digital television module is further configured to obtain the a channel program identifier from the media processing module, determine whether the corresponding program is a scrambled program, and acquire program parameters if the corresponding program is a scrambled program, the program parameters comprising a video stream identifier videoPid, an audio stream identifier audioPid, a conditional access application identifier casId, an entitlement control message identifier ecmPid, an entitlement management message identifier emmPid of the channel program;
the media processing module is configured to acquire, from the digital television module, the video stream identifier videoPid, the audio stream identifier audioPid, the conditional access application identifier casId, the entitlement control message identifier ecmPid, and the entitlement management message identifier emmPid of the channel program, and transmit the same to the conditional access module;
the conditional access module is configured to parse the entitlement control message identifier ecmPid and the entitlement management message identifier emmPid according to a parsing mechanism that matches the received conditional access application identifier casId, so as to obtain encryption level keys EK1 and EK2 and an encryption control word ECW;
the media processing module is further configured to acquire the encryption level keys EK1 and EK2 and the encryption control word ECW from the conditional access module, and control descrambler hardware to descramble program data using the encryption level keys EK1 and EK2 and the encryption control word ECW;
the DRM management service module is configured to control the trusted application in the trusted execution environment to generate a content encryption key CEK, control the trusted application to encrypt the descrambled program data using the content encryption key CEK, and transmit the same to the terminal through the digital television gateway service module; and
the trusted application in the trusted execution environment is configured to generate the content encryption key CEK and encrypt the descrambled program data using the content encryption key CEK, obtain from the terminal through the digital television gateway service module a public key used to encrypt the content encryption key CEK, encrypt the content encryption key CEK using the public key to obtain an encrypted content encryption key ECEK, and transmit the ECEK to the terminal.

15. The device according to claim 14, wherein the trusted execution environment (TEE) comprises a hardware resource, an internel API, and a secure operating system that are isolated from an operating system of the media gateway.

16. The device according to claim 14, wherein a DRM digital certificate is stored in the DRM management service module, and
the digital television gateway service module is further configured to:
acquire the DRM digital certificate through the DRM management service module and transmit the same to the terminal for the terminal to perform certificate verification and validity authentication; and
receive a DRM digital certificate transmitted by the terminal, and perform certificate verification and validity authentication on the DRM digital certificate transmitted by the terminal through the trusted application in the trusted execution environment, the DRM digital certificate transmitted by the terminal comprising the public key used to encrypt the content encryption key CEK.

17. The device according to claim 14, wherein the media processing module is further configured to: when the digital television module determines that the corresponding program is a non-scrambled program, provide the acquired program data stream to the terminal.

18. The device according to claim 14, wherein the program parameters further comprise a frequency locking parameter of the program; and
the media processing module is further configured to configure the acquired frequency locking parameter of the program into a tuner of the media gateway, and configure the video stream identifier videoPid and the audio stream identifier audioPid of the channel program to demultiplexer hardware to filter the program data stream.

19. The device according to claim 14, wherein the digital television gateway service module is further configured to configure an operation mode as a media gateway mode.

20. The device according to claim 14, wherein the channel program identifier comprises an original network identifier onid, a transport stream identifier tsid, and a service identifier sid of the channel.

21. A terminal device of a digital rights management (DRM)-enabled media gateway, the device comprising a gateway application module, a trusted execution environment (TEE) and a trusted application configured therein, a digital television gateway service module, a media processing module, and a DRM management service module; wherein
the gateway application module is configured to request a list of all channel programs from the media gateway and display the same through the digital television gateway service module, and transmit a switched channel program identifier to the media gateway in response to a user's channel change instruction or program playing instruction;
the media processing module is configured to acquire a program data stream encrypted using a content encryption key CEK from the media gateway when the corresponding program is a scrambled program;
the DRM management service module is configured to transmit a public key used to encrypt the content encryption key CEK to the media gateway through the digital television gateway service module, receive an encrypted content encryption key ECEK encrypted with the public key transmitted by the media gateway through the digital television gateway service module and configure the same into the trusted application in the trusted execution environment;
the trusted application in the trusted execution environment is configured to acquire a private key paired with the public key according to a preset mechanism, and decrypt the encrypted content encryption key ECEK using the private key to obtain the content encryption key CEK; and
the media processing module is further configured to control, by the DRM management service module, the trusted application in the trusted execution environment to decrypt the acquired encrypted program data stream using the content encryption key CEK for playing.

22. The device according to claim 21, wherein the trusted execution environment (TEE) comprises a hardware resource, an internel API, and a secure operating system that are isolated from an operating system of the media gateway.

23. The device according to claim 21, wherein the DRM management service module stores a DRM digital certificate, and the digital television gateway service module is further configured to:
transmit the DRM digital certificate to the media gateway for the media gateway to perform certificate verification and validity authentication, the DRM digital certificate comprising the public key used to encrypt the content encryption key CEK; and
receive a DRM digital certificate transmitted by the media gateway, and perform certificate verification and validity authentication on the DRM digital certificate transmitted by the media gateway through the trusted application in the trusted execution environment.

24. The device according to claim 21, wherein the media processing module is further configured to obtain the program data stream from the media gateway when the corresponding program is a non-scrambled program.

25. The device according to claim 21, wherein the digital television gateway service module is further configured to configure an operation mode to a terminal mode.

26. The device according to claim 21, wherein the channel program identifier comprises an original network identifier onid, a transport stream identifier tsid, and a service identifier sid of the channel.

27. A dual-function device of a digital rights management (DRM)-enabled media gateway, comprising a digital television gateway service module configured to configure an operation mode of the device as a media gateway mode or a terminal mode,
wherein when the operation mode is configured as the media gateway mode, the device is configured to perform the following steps:
acquiring a list of all channel programs and transmitting the same to a terminal;
receiving a channel program identifier transmitted from the terminal indicating a user's channel change instruction or program playing instruction to acquire a corresponding program data stream;
if the corresponding program is a scrambled program, acquiring program parameters, the program parameters comprising a video stream identifier videoPid, an audio stream identifier audioPid, a conditional access application identifier casId, an entitlement control message identifier ecmPid, and an entitlement management message identifier emmPid of the channel program;
parsing the entitlement control message identifier ecmPid and the entitlement management message identifier emmPid using a parsing mechanism that matches the conditional access application identifier casId, thereby obtaining encryption level keys EK1 and EK2 and an encryption control word ECW;
descrambling the scrambled program data stream using the encryption level keys EK1 and EK2, the encryption control word ECW, the video stream identifier videoPid, and the audio stream identifier audioPid of the channel program;
generating a content encryption key CEK by the trusted application in the trusted execution environment, and encrypting the descrambled program data using the content encryption key CEK and transmitting the same to the terminal; and
acquiring a public key used to encrypt the content encryption key CEK from the terminal, encrypting the content encryption key CEK with the public key by the trusted application in the trusted execution environment to obtain an encrypted content encryption key ECEK and transmitting the ECEK to the terminal;
and when the operating mode is configured as the terminal mode, the device is configured to perform the following steps:
requesting a list of all media channels from the media gateway;
in response to a user's channel change instruction or program playing instruction, transmitting a switched channel program identifier to the media gateway;
if the corresponding program is a scrambled program, acquiring a program data stream encrypted using a content encryption key CEK from the media gateway;
transmitting a public key used to encrypt the content encryption key CEK to the media gateway;
receiving an encrypted content encryption key ECEK encrypted with the public key transmitted by the media gateway, and configuring the same into the trusted application in the trusted execution environment;
acquiring, by the trusted application in the trusted execution environment, a private key paired with the public key according to a preset mechanism, and decrypting the encrypted content encryption key ECEK by using the private key to obtain the content encryption key CEK; and
decrypting the acquired encrypted program data stream using the content encryption key CEK for playing.
